(19) United States
(12) Patent Application Publication
(10) Pub. No.: US 2007/0092331 A1
(43) Pub. Date: Apr. 26, 2007

(54) Method of assembling an armature to a solid pusher, and the resulting assembly

(75) Inventors: Christophe Maerky, Saint Ouen L'Aumone (FR); Guillaume Coudure-Tuquet, Saint Vallier (FR)

Correspondence Address: BIRCH STEWART KOLASCH & BIRCH, PO BOX 747, FALLS CHURCH, VA, 22040-0747, US

(73) Assignee: VALEO SYSTEMES DE CONTROLE MOTEUR, Osny (FR)

(21) Appl. No.: 10/555,607

(22) PCT Filed: May 6, 2003
(86) PCT No.: PCT/FR03/01402

§ 371 Date: Dec. 18, 2006

(51) Int. Cl. F16D 1/072

(52) U.S. Cl. 403/282; 29/525

(57) ABSTRACT

The invention relates to a method of assembling an armature (3) to a solid pusher (1) extending through an opening (4) in the armature (3), the method comprising the steps of:
making at least one groove (2) in the pusher (1); then
inserting the pusher (1) into the opening (4) in the armature (3) so that the groove (2) extends substantially adjacent to a face of the armature (3), and interposing between the pusher (1) and the armature (3) a ring (5) that projects on either side of the armature (3) and that overlies the groove (2); and then
crimping the ring (5) on either side of the armature (3) while holding the armature (3) perpendicular to the pusher (1).

The invention relates to a method of assembling an armature to a solid pusher extending through an opening in the armature, and to the resulting assembly.

### BACKGROUND OF THE INVENTION

In certain prior art electromagnetic actuators, the armature is crimped directly onto the pusher. For example, it is possible to use the assembly method described in document FR-A-2 573 140, in which the pusher is engaged as a force-fit in the armature, and then the armature is crimped onto the pusher.

That method suffers from various drawbacks. Firstly, the armature must be made out of a metal that can be crimped, and that type of metal does not necessarily have good magnetic characteristics.

In addition, during the forced engagement or during crimping, there is a risk of the armature deforming so that the planeness of the active faces of the armature or the perpendicularity of said faces relative to the pusher are degraded, giving rise to interfering airgaps between the armature and the stators of the actuator leading to an increase in the electricity consumption of such actuators.

In order to remedy such deformation, it is necessary to make provision for corrective machining operations on the armature, and that is expensive.

In a very different field, U.S. Pat. No. 4,656,721 discloses a method of assembling a hollow rung bar to a latter rail, the method comprising the steps of inserting the bar into an opening in the rail with a ring being interposed between them, and of crimping the ring on either side of the rail. During crimping, a tool with a spherical end is inserted into the bar in order to form simultaneously a groove in the bar and a ring-anchoring portion in relief penetrating into the groove. Nevertheless, that method is not adaptable to solid pushers.

Also in a field that is very remote, document GB-A-2 042 124 discloses a method of assembling a bearing for rotation. That method includes steps of inserting a shaft into a sleeve with centering rings being interposed between them, and then crimping an abutment member in order to hold the sleeve axially in place.

### OBJECT OF THE INVENTION

The assembly method of the invention seeks to remedy those drawbacks.

### BRIEF SUMMARY OF THE INVENTION

The method of the invention for assembling an armature to a solid pusher extending through an opening in the armature comprises the following steps:

making at least one groove in the pusher; then inserting the pusher into the opening in the armature so that the groove extends substantially adjacent to a face of the armature, and interposing between the pusher and the armature a ring that projects on either side of the armature and that overlies the groove; and then

crimping the ring on either side of the armature while holding the armature perpendicular to the pusher.

Thus, the crimping deforms the ring so as to create beads on the ring on either side of the armature, together with an anchoring portion in relief that extends into a groove of the pusher, thereby preventing the armature from moving relative to the pusher.

In the method of the invention, the armature is no longer directly subjected to the crimping force and the risks of deforming the armature is thus minimized, such that the planeness of its active faces and the perpendicularity of said faces relative to the pusher are preserved. In addition, since the crimping is performed on the insert ring, the armature can be made of a metal that is more advantageous from the magnetic point of view than are the metals commonly used for crimping.

In a preferred variant of the invention, two grooves are formed in the pusher each extending substantially adjacent to a respective face of the armature. Crimping then gives rise to two anchoring portions in relief each extending into the corresponding groove, thus causing the resulting anchoring to be stronger.

### BRIEF DESCRIPTION OF THE DRAWING

Other characteristics and advantages of the invention appear more clearly in the light of the following description of a particular and non-limiting implementation of the invention given with reference to the figures of the accompanying drawing, in which:

FIG. 1 is a section view of a pusher and an armature assembled together by the method of the invention, the left-hand half of the figure showing the parts prior to crimping while the right-hand half of the figure shows the parts after crimping; and

FIG. 2 is a side view in partial section showing the crimping member prior to the crimping operation.

### DETAILED DESCRIPTION OF THE INVENTION

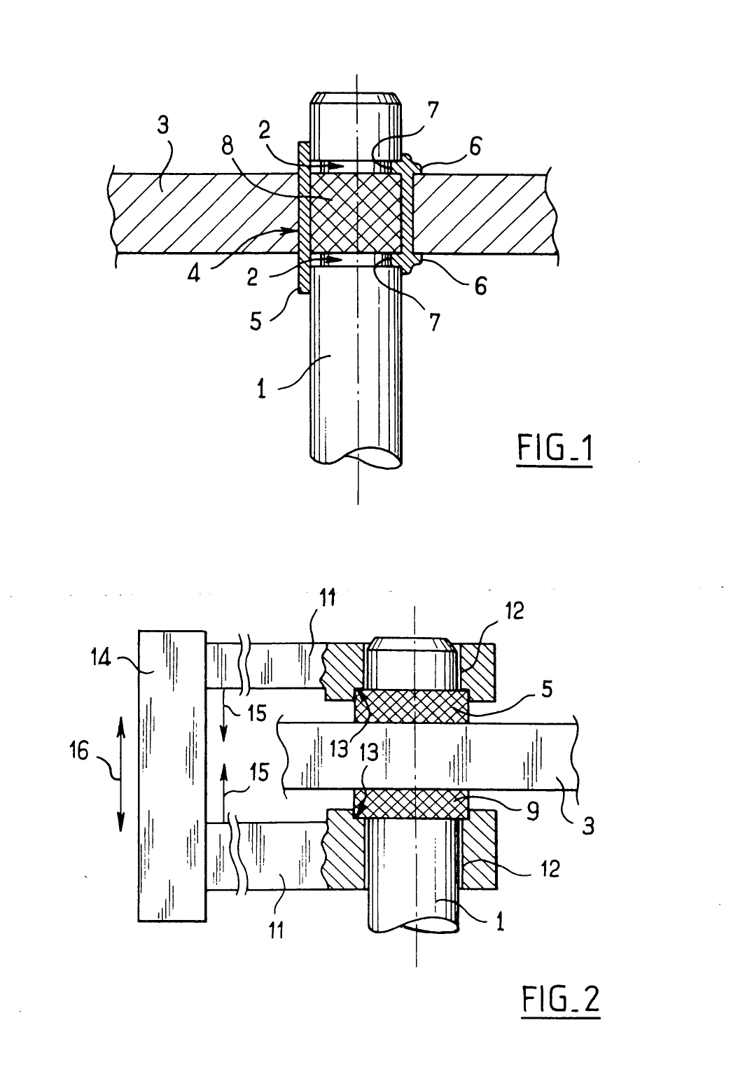

With reference to FIG. 1, in the preferred implementation of the invention, two grooves 2 are formed in the solid pusher 1, the grooves 2 being spaced apart by a distance equal to the thickness of the armature 3, and serrations 8 are made, e.g. by knurling, in the surface of the pusher 1 in its portion that extends between the grooves 2. A ring 5 whose outside surface includes serrations 9 (see FIG. 2) is engaged on the pusher, and together they are inserted into an opening in the armature 3.

The pusher 1 and the armature 3 are held by tooling (not shown) in the position shown, in which each of the grooves 2 lies substantially adjacent to a corresponding face of the armature 3. The tooling includes positioning means (not shown) serving to position the armature 3 and the pusher 1 in such a manner that the armature 3 extends perpendicularly to the pusher 1. The positioning means include clamping means enabling the armature 3 and the pusher 1 to be held stationary in this position during crimping.

The opening in the armature 3, the ring 5, and the pusher 1 are designed so as to leave between them assembly clearance that makes it easy to put these parts into place, and also allows the material of the ring 5 to flow during crimping.

Thereafter, the method comprises the step of crimping the ring 5 on either side of the armature 3, using a crimping member as shown in FIG. 2. The result of the crimping operation is shown in the right-hand half of FIG. 1.

The crimping operation gives rise to beads 6 on the ring 5 on either side of the armature 3, thereby clamping against it.

Furthermore, anchoring portions 7 in relief on the ring 5 are urged into the grooves 2 under the crimping force, thereby preventing the armature 3 from moving relative to the pusher 1.

The armature 3 is prevented from turning relative to the pusher 1 by the clamping caused by the radial expansion of the ring 5 in the opening 4 through the armature 3 under the effect of the compression force used for crimping.

The serrations 8 made on the pusher 1 between the grooves 2, i.e. in the zone of the pusher 1 that remains covered by the ring 5 after crimping, and the serrations 9 formed in the outside face of the ring 5 reinforces prevention of the armature and the pusher turning relative to each other.

By way of example, the ring 5 may be made of a steel of type XC10, which is easily worked by crimping.

The armature 3 could, for example, be made of an iron and silicon alloy that is known for its good magnetic properties, or out of any other material having suitable magnetic behavior.

In order to perform crimping, it is preferable to use a crimping tool 10 as shown in FIG. 2, comprising two jaws 11 that present respective passages 12 for receiving the pusher 1 and respective bearing surfaces 13 for bearing against the ring 5.

The jaws 11 are secured to a support 14, and one or both jaws are movable in the direction of arrows 15 so as to enable them to be moved towards each other during crimping under drive from an actuator (not shown).

Advantageously, provision is made to mount the support 14 for the crimping member with a degree of freedom to move relative to the tooling that holds the armature 3 and the pusher 1. During crimping, the support 14 is then free to move axially as represented by double-headed arrow 16 so as to avoid deforming the armature even if the movement of the jaws 10 is not symmetrical relative to the armature. A degree of freedom is also provided for the support 14 of the crimping member 10 to move radially so as to avoid bending the pusher 1 during crimping. These dispositions make it possible to ensure that the faces of the armature 3 remain perpendicular relative to the pusher 1, and also to ensure that the faces of the armature 3 remain plane, without it being necessary to perform machining on the armature after crimping.

The invention is not limited to the particular embodiments described above, but on the contrary extends to cover any variant coming within the ambit of the invention as defined by the claims.

In particular, although it is stated that two grooves are formed in the pusher, where appropriate only a single groove need be provided, thus simplifying assembly, but leading to a connection that is not so strong.

Although it is stated that serrations are formed on the pusher and on the ring, it is possible to use a pusher and a ring that are smooth if the crimping is found to prevent relative turning to an extent that is considered as being satisfactory.

A washer may be interposed on each of the faces of the armature prior to crimping.

What is claimed is:

1. A method of assembling an armature (3) to a solid pusher (1) extending through an opening (4) in the armature (3), the method comprising the steps of:
making at least one groove (2) in the pusher (1); then
inserting the pusher (1) into the opening (4) in the armature (3) So that the groove (2) extends substantially adjacent to a face of the armature (3), and interposing between the pusher (1) and the armature (3) a ring (5) that projects on either side of the armature (3) and that overlies the groove (2); and then
crimping the ring (5) on either side of the armature (3) while holding the armature (3) stationary relative to the pusher (1) and perpendicular thereto.

2. A method of assembly according to claim 1, wherein the crimping is performed by means of a crimping member (10) that is mounted free to move relative to the armature (3) and to the pusher (1) during crimping.

3. An assembly comprising an armature (3) and a solid pusher (1) extending through an opening (4) in the armature, wherein the pusher includes at least one groove (2), and wherein the assembly includes a ring extending between the armature and the pusher, and into the groove of the pusher, the ring being crimped on either side of the armature.

4. An assembly according to claim 3, wherein the pusher (1) has two grooves (2) each extending substantially adjacent to a respective face of the armature (3).

5. An assembly according to claim 3, wherein the pusher (1) has serrations (8) in a zone that remains covered by the ring (5) after crimping.

6. An assembly according to claim 3, wherein the ring (5) includes external serrations (9) over a zone that is engaged in the opening (4) of the aramture (3).
